(19) United States
(12) Patent Application Publication
(10) Pub. No.: US 2022/0215373 A1
(43) Pub. Date: Jul. 7, 2022

(54) ELECTRONIC DEVICE, MANAGEMENT METHOD OF ELECTRONIC DEVICE, AND PROGRAM

(71) Applicant: Sharp NEC Display Solutions, Ltd., Tokyo (JP)

(72) Inventors: Masakazu KOBAYASHI, Tokyo (JP); Katsuyuki TAKEUCHI, Tokyo (JP)

(21) Appl. No.: 17/702,516

(22) Filed: Mar. 23, 2022

Related U.S. Application Data
(63) Continuation of application No. PCT/JP2019/037600, filed on Sep. 25, 2019.

(51) Int. Cl. G06Q 20/28; G06Q 20/38; G06Q 30/06

(52) U.S. Cl. CPC G06Q 20/28; G06Q 30/06; G06Q 20/3825

(57) ABSTRACT

An electronic device, includes operation condition storage storing information of operation conditions for specifying operation conditions of the electronic device, a time information storage storing time information that is information for specifying at least one of a usable time and an expiration period of the electronic device in the information of operation conditions, a change input receiving a change input of the information of operation conditions, and a changer changing the information of operation conditions stored by the operation condition storage according to the change input and calculate the usable time in the changed information of operation conditions.

### TECHNICAL FIELD

The present invention relates to an electronic device, a management method of an electronic device, and a program.

### BACKGROUND ART

Currently, electronic devices such as projectors and displays are used in various places. In general, these electronic devices are often used after being bought by users.

Note that Patent Literature 1 describes a system for a user to use a paid service. In this system, processing related to charging a user is performed by a centralized management platform.

### CITATION LIST

### Patent Literature

[Patent Literature 1]

Published Japanese Translation No. 2004-545014 of the PCT International Publication

### SUMMARY OF INVENTION

### Technical Problem

The present inventor has investigated lending of electronic devices to users and having the users pay in advance a price corresponding to operation conditions and a usage time of the electronic device at the time of lending. In this case, a user may desire to change the operation conditions of the electronic device during use. On the other hand, it may not be possible to connect the electronic device to the Internet depending on a usage environment in which the electronic device is used.

An object of the present invention is to make it possible to change operation conditions of an electronic device during use even if the electronic device cannot be connected to the Internet when the electronic device is lent and a price corresponding to the operation conditions and the usage time of the electronic device is paid in advance at the time of lending.

### Solution to Problem

According to the present invention, there is provided an electronic device, including operation condition storage storing information of operation conditions for specifying operation conditions of the electronic device, a time information storage storing time information that is information for specifying at least one of a usable time and an expiration period of the electronic device in the information of operation conditions, a change input receiving a change input of the information of operation conditions, and a changer changing the information of operation conditions stored by the operation condition storage according to the change input and calculate the usable time in the changed information of operation conditions.

According to the present invention, there is provided a management method of an electronic device, including, by an electronic device, storing information of operation conditions for specifying operation conditions of the electronic device, storing time information that is information for specifying a usable time or an expiration period of the electronic device in the information of operation conditions, receiving a change input of the information of operation conditions, and changing the information of operation conditions stored by the operation condition storage according to the change input and calculating the usable time in the changed information of operation conditions.

According to the present invention, there is provided a program causing an electronic device to have a function of storing information of operation conditions for specifying operation conditions of the electronic device, a function of storing time information that is information for specifying a usable time or an expiration period of the electronic device in the information of operation conditions, a function of receiving a change input of the information of operation conditions, and a function of changing the information of operation conditions stored by the operation condition storage according to the change input and calculating the usable time in the changed information of operation conditions.

### Advantageous Effects of Invention

According to the present invention, when the electronic device is lent and a price corresponding to operation conditions and a usage time of the electronic device is paid in advance at the time of lending, it is possible to change the operation conditions of the electronic device during use even if the electronic device cannot be connected to the Internet.

### BRIEF DESCRIPTION OF DRAWINGS

The object described above and other objects, features, and advantages will be further clarified by preferred embodiments described below and accompanying drawings thereof.

FIG. 1 is a diagram which shows an example of a functional configuration of an electronic device according to an embodiment.

FIG. 2 is a diagram which shows an example of information stored by operation condition storage.

FIG. 3 is a diagram which shows an example of information stored by a time information storage.

FIG. 4 is a block diagram which exemplifies a hardware configuration of a main part of the electronic device.

FIG. 5 is a diagram which shows a first example of processing performed by the electronic device.

FIG. 6 is a diagram which shows a second example of the processing performed by the electronic device.

FIG. 7 is a diagram which shows a third example of the processing performed by the electronic device.

### DESCRIPTION OF EMBODIMENTS

Hereinafter, an embodiment of the present invention will be described with reference to the drawings. In all drawings, the same components will be denoted by the same reference numerals and descriptions thereof will be omitted as appropriate.

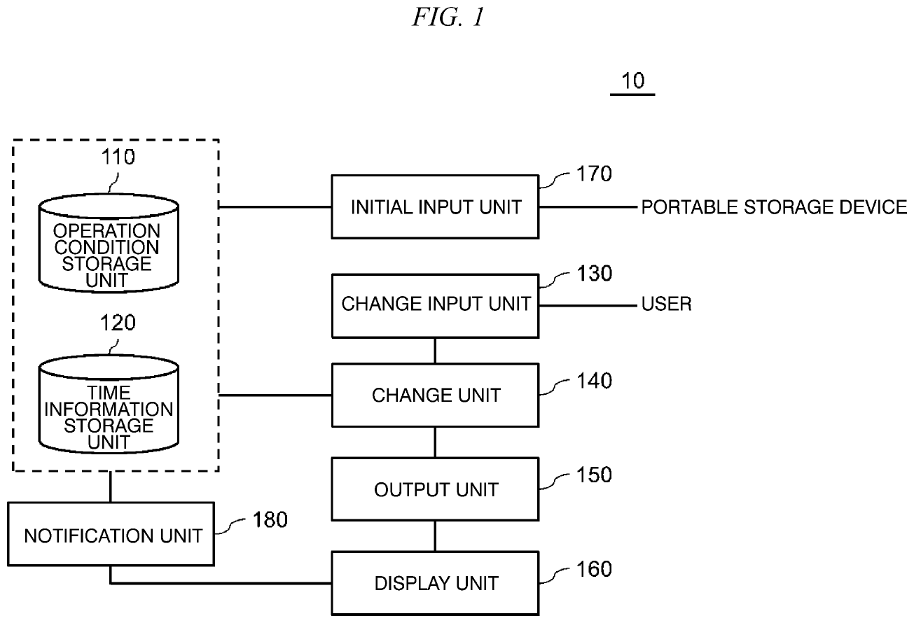

FIG. 1 is a diagram which shows an example of a functional configuration of an electronic device 10 according to an embodiment. The electronic device 10 shown in FIG. 1 is, for example, an office device and is lent to a user. The electronic device 10 is, for example, a display device such as a display or a projector, but may be a copying machine or a multifunction device having a copying function and a fax function.

In the present embodiment, the electronic device 10 is not connected to the Internet. For this reason, it is difficult to perform charging based on a meter rate system on the electronic device 10. Therefore, a user pays in advance a price for the lending (hereinafter referred to as a prepaid amount). A usable time of the electronic device 10 is determined according to this prepaid amount. Then, the electronic device 10 stores information for specifying a current usable time (a remaining time within an allowed time), and updates the information according to a total amount of time for which the electronic device 10 has already been used (hereinafter referred to as a usage time). Then, a controller of the electronic device 10 causes the function of the electronic device 10 to stop when the usable time is zero.

The price of the electronic device 10 per unit time may change depending on an operation state of the electronic device 10 when the electronic device 10 is used. The operation state allowed for the electronic device 10 varies depending on a type of a contract (for example, a contract plan) selected by a user. As an example, when lifespans of components constituting the electronic device 10 vary depending on the operation state (for example, a ratio of an allowable output to a rated output), a unit price per unit time varies depending on an operating state allowed by a corresponding contract. For this reason, even if the prepaid amount is the same, the usable time of the electronic device 10 varies depending on a selected contract plan. In the present embodiment, the electronic device 10 stores information for specifying the type of the selected contract (hereinafter referred to as information of operation conditions).

For example, when the electronic device 10 is a projector, a light source is likely to deteriorate. Therefore, an output of the light source allowed for the electronic device 10 (that is, a brightness of the projector) varies depending on a contract plan. For this reason, the usable time or prepaid amount of the electronic device 10 varies depending on a contract plan. This output is determined based on, for example, the rated output of the light source.

On the other hand, some users of the electronic device 10 may desire to change a contract plan (that is, operation conditions of the electronic device 10) during a contract period. In this case, when the contract plan is changed, the electronic device 10 stores the changed information of operation conditions and corrects the current usable time according to the changed information of operation conditions.

Specifically, the electronic device 10 includes operation condition storage 110, a time information storage 120, a change input 130, and a changer 140. The operation condition storage 110 stores the information of operation conditions of the electronic device 10. The time information storage 120 stores information (hereinafter referred to as time information) for specifying a usable time or an expiration period of the electronic device in the information of operation conditions. The change input 130 receives a change input of the information of operation conditions. This change input is performed by, for example, a user operating an input device (for example, a button or a touch panel) provided on the electronic device 10. The changer 140 changes (updates) the information of operation conditions stored by the operation condition storage 110 according to this change input, and calculates the usable time in the changed information of operation conditions.

In addition, when the electronic device 10 is used, the changer 140 updates time information according to a usage time. For example, when the time information includes a usable time, the changer 140 subtracts the usage time from the usable time. Moreover, when the usable time includes a balance of a prepaid amount, the changer 140 subtracts a value obtained by multiplying the usage time by a unit price of a current contract plan from the balance.

In the example shown in FIG. 1, the electronic device 10 further includes an output 150 and a display 160. The output 150 outputs at least one of a usable time after the change and an expiration period calculated using the usable time after the change. An example of an output destination of the output 150 is the display 160. The display 160 is, for example, a liquid crystal display or a touch panel (which also serves as an input device in this case), and displays information output by the output 150. As a result, a user of the electronic device 10 can confirm at least one of the usable time after the change and the expiration period when the operation conditions, that is, a contract plan, is changed.

When the electronic device 10 is a display, the display 160 may be a display such as a display panel. Moreover, when the electronic device 10 is a projector, the display 160 may be a projection unit of the projector. In these cases, it is preferable that the output 150 output the information described above at a timing when the user starts using the electronic device 10 (that is, when a power button is turned on) and a timing when the user stops using the electronic device 10 (that is, when the power button is turned off).

In the example shown in FIG. 1, the electronic device 10 further has an initial input 170 and a notifier 180. The initial input 170 acquires the first information of operation conditions, that is, the information of operation conditions at the time of lending, and stores it in the operation condition storage 110, and also acquires the first time information, that is, the time information at the time of lending, and causes the time information storage to store it in the time information storage 120. The electronic device 10 is not connected to the Internet. For this reason, the initial input 170 acquires the information of operation conditions at the beginning of lending and the time information at the beginning of lending from a portable storage device (for example, a portable memory). However, when the electronic device 10 can be connected to the Internet, the initial input 170 may acquire the information of operation conditions at the beginning of lending and the time information at the beginning of a contract via the Internet.

The notifier 180 outputs a predetermined notification when an end timing of a contract to use the electronic device 10 is approaching. This notification involves, for example, causing the display 160 to display a predetermined character string. The notifier 180 determines that the end timing of the contract to use the electronic device 10 is approaching when the difference between an expiration period of the electronic device specified by the time information and a current date and time satisfies a reference (is equal to or less than a predetermined value, for example).

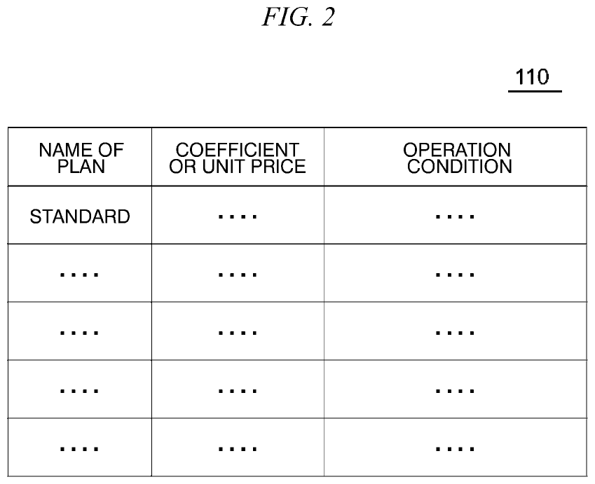

FIG. 2 is a diagram which shows an example of information stored by the operation condition storage 110. In the example shown in FIG. 2, the operation condition storage 110 stores a name of a corresponding plan, the operation conditions of the electronic device 10 in a corresponding plan, and a “coefficient” or “unit price” of a corresponding plan for each contract plan.

For example, when the electronic device 10 is a projector, the operation conditions of the electronic device 10 includes a model number of the electronic device 10, a model number of a light source of the electronic device 10, and an output allowed for the light source (for example, a relative value based on the rated output).

The “coefficient” is a ratio of the unit price of a corresponding contract plan or a ratio of an operable time when the same prepaid amount is paid with respect to a contract plan serving as a reference (described as “standard” in FIG. 2). In addition, time information indicates a usable time. Then, the changer 140 determines the coefficient on the basis of a combination of the information of operation conditions before the change and the changed information of operation conditions, and calculates the usable time after the change by multiplying the usable time before the change by the coefficient. For example, when the “coefficient” shown in FIG. 2 is a ratio of the unit price, the changer 140 calculates the usable time after the change by multiplying the usable time before the change by the “coefficient before the change or coefficient after the change.” In addition, when the “coefficient” shown in FIG. 2 is the ratio of the operable time, the changer 140 calculates the usable time after the change by multiplying the usable time before the change by the “coefficient after the change or the coefficient before the change.”

The “unit price” is a unit price per unit operation time in a corresponding contract plan. The time information is the balance of a prepaid amount (that is, a value obtained by subtracting “usage time of the electronic device 10 so far”×“unit price per hour of the selected contract plan” from the prepaid amount). Then, the changer 140 calculates the usable time after the change by dividing this balance by a unit price of the changed contract plan (that is, a constant determined on the basis of the changed information of operation conditions).

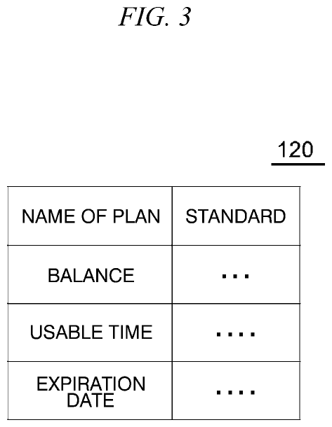

FIG. 3 is a diagram which shows an example of information stored by the time information storage 120. In the example shown in FIG. 3, the time information storage 120 stores a currently selected contract plan (information of operation conditions), a balance, a usable time, and an expiration period. However, depending on a type of the electronic device 10 and a contract plan, it may not be possible to set the expiration period. In this case, the time information storage 120 does not store the expiration period.

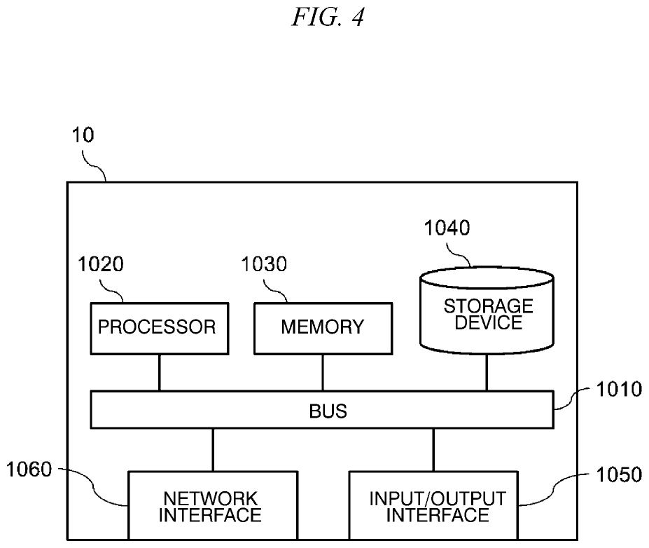

FIG. 4 is a block diagram which exemplifies a hardware configuration of a main part of the electronic device 10. This main part has a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit or receive data to or from each other. However, a method of connecting the processor 1020 and the like to each other is not limited to a bus connection.

The processor 1020 is a processor realized by a central processing unit (CPU), a graphics processing unit (GPU), or the like.

Memory 1030 is a main storage device realized by a random access memory (RAM) or the like.

The storage device 1040 is an auxiliary storage device realized by a hard disk drive (HDD), a solid state drive (SSD), a memory card, a read only memory (ROM), or the like. The storage device 1040 stores a program module that realizes each function of the electronic device 10 (for example, the change input 130, the changer 140, the output 150, the initial input 170, and the notifier 180). The processor 1020 reads each of these program modules onto the memory 1030 and executes them, thereby realizing each function corresponding to each program module. In addition, the storage device 1040 also functions as various storages (for example, the operation condition storage 110 and the time information storage 120).

The input/output interface 1050 is an interface for connecting the main part of the electronic device 10 and various input/output devices (for example, the display 160).

The network interface 1060 is an interface for connecting the electronic device 10 to other devices on the network. However, the network interface 1060 may not be used.

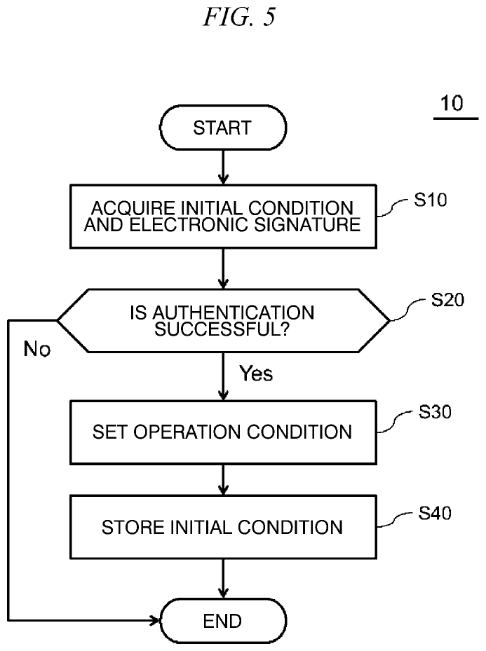

FIG. 5 is a diagram which shows a first example of processing performed by the electronic device 10. Processing shown in FIG. 5 is processing in which the electronic device 10 acquires the first information of operation conditions and the first time information (hereinafter referred to as initial conditions).

Initial conditions are stored in a portable memory. The user of the electronic device 10 or an owner of the electronic device 10 (in a case of a corporation, this may be a sales representative of the corporation) inserts a portable memory that stores the initial conditions into a terminal of the electronic device 10. In this memory, an electronic signature is linked with the initial conditions. Then, the initial input 170 of the electronic device 10 reads the initial conditions and the electronic signature (step S10), and, when the electronic signature is successfully authenticated (Yes in step S20), the first operation condition included in the initial conditions is set for the electronic device 10 (step S30). Then, the initial input 170 causes the operation condition storage 110 to store the first information of operation conditions and causes the time information storage 120 to store the first time information (step S40).

As described above, processing shown in step S10 may be performed via the Internet.

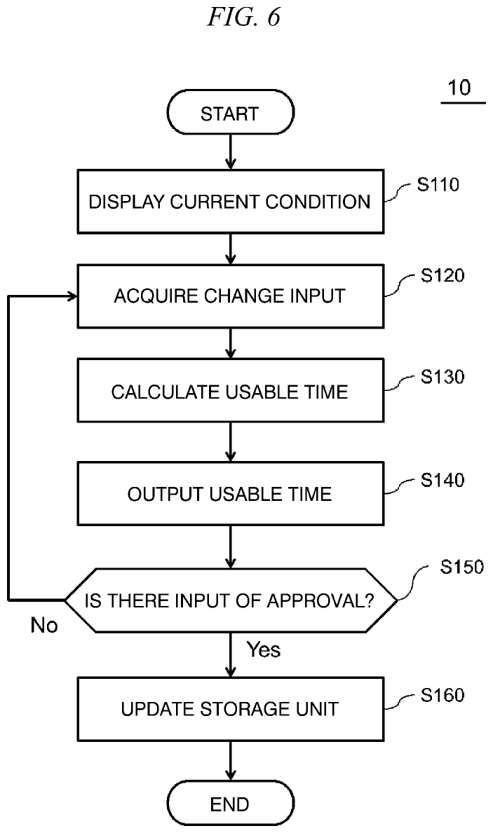

FIG. 6 is a diagram which shows a second example of the processing performed by the electronic device 10. Processing shown in FIG. 6 is processing when the user of the electronic device 10 changes the contract plan during use.

First, when the user of the electronic device 10 performs an input to the effect that it changes a contract plan (for example, to select a corresponding item on a screen), the change input 130 of the electronic device 10 displays a current contract plan (that is, information of operation conditions) (step S110). Then, the user inputs a changed contract plan (that is, information of operation conditions) to the electronic device 10 (step S120).

When the change input 130 of the electronic device 10 acquires the changed information of operation conditions, it calculates the usable time after the change (step S130) and outputs the calculated usable time to the display 160 (step S140). A specific example of the method of calculating the usable time is as described with reference to FIG. 2. The display 160 displays the usable time. The user of the electronic device 10 performs an input to the effect that the user approves the changed information of operation conditions when the displayed usable time is allowable (Yes in step S150). Then, the change input 130 updates the operation condition storage 110 and the time information storage 120 (step S160).

If the user performs an input to the effect that the user cannot approve the changed information of operation conditions (No in step S150), the processing returns to step S120.

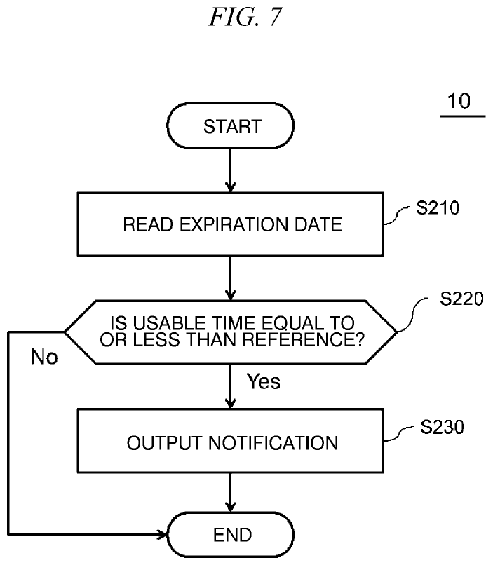

FIG. 7 is a diagram which shows a third example of the processing performed by the electronic device 10. FIG. 7 shows processing performed by the notifier 180. The notifier 180 performs the processing shown in FIG. 7 when a predetermined condition is satisfied. An example of the predetermined condition is, as described above, at least one of a time when the user turns on the power button of the electronic device 10 and a time when the user turns off the power button of the electronic device 10.

The notifier 180 reads the usable time from the time information storage 120 (step S210), and, when this usable time is equal to or less than a reference (Yes in step S220), it displays an output indicating that the end timing of a contract is approaching on the display 160 (step S230). The display 160 displays this output.

As described above, according to the present embodiment, the electronic device 10 stores information (time information) for specifying the usable time of the electronic device 10 when it is lent to a user. Then, when the operation conditions of the electronic device 10, that is, the contract plan, is changed, the usable time is changed to cope with a charge plan after the change by performing an arithmetic operation according to the change plan. Then, when the usable time is 0, the controller of the electronic device 10 prevents a function as the electronic device 10 from working. Therefore, even if the electronic device 10 is not connected to the Internet, the user of the electronic device 10 can change the contract plan during use.

Although the embodiment of the present invention has been described as above with reference to the drawings, it is an example of the present invention, and various configurations other than described above can be adopted.

Further, in the plurality of flowcharts used in the description above, a plurality of processes (processes) are described in order, but an order of executing the processes to be executed in each embodiment is not limited to the order of description. In each embodiment, the order of the processes shown can be changed within a range that there is no trouble with the contents. In addition, the embodiment described above can be combined as long as the contents do not conflict with each other.

A part or all of the embodiment described above may be described as in the following appendix, but is not limited to the following.

1. An electronic device includes operation condition storage storing information of operation conditions for specifying operation conditions of the electronic device, a time information storage storing time information that is information for specifying a usable time or an expiration period of the electronic device in the information of operation conditions, a charge input receiving a change input of the information of operation conditions, and a changer changing the information of operation conditions stored by the operation condition storage according to the change input and calculating the usable time in the changed information of operation conditions.

2. In the electronic device according to the appendix 1 described above, the time information indicates a usable time, and the changer determines a coefficient on the basis of a combination of the information of operation conditions before the change and the changed information of operation conditions and calculates the usable time after the change by multiplying the usable time before the change by the coefficient.

3. In the electronic device according to the appendix 1 described above, the time information indicates a balance of a prepaid amount, and the changer calculates the usable time after the change by dividing the balance by a constant determined on the basis of the changed information of operation conditions.

4. In the electronic device according to any one of the appendixes 1 to 3 described above, an output outputting at least one of the usable time after the change and an expiration period calculated using the usable time after the change is further included.

5. In the electronic device described in any one of the appendixes (1) to (4) described above, an initial input acquiring the first information of operation conditions to cause the operation condition storage to store the first information of operation conditions, and acquiring the first time information to cause the time information storage to store the first time information is further included.

6. In the electronic device according to the appendix 5 described above, the first information of operation conditions and the first time information have an electronic signature, and the initial input causes the operation condition storage to store the first information of operation conditions and causes the time information storage to store the first time information when the electronic signature is authenticated.

7. In the electronic device according to any one of the appendixes 1 to 5 described above, when a difference between an expiration period of the electronic device specified by the time information and a current date and time satisfies a reference, or when the usable time is equal to or less than a reference, a notifier outputting a predetermined notification is further included.

8. In the electronic device according to any one of the appendixes 1 to 7 described above, the electronic device is a display device or a projector.

9. A management method of the electronic device includes storing information of operation conditions for specifying operation conditions of the electronic device, storing time information that is information for specifying a usable time or an expiration period of the electronic device in the information of operation conditions, receiving a change input of the information of operation conditions, changing the stored information of operation conditions according to the change input, and calculating the usable time in the changed information of operation conditions.

10. In the management method of an electronic device according to the appendix 9 described above, the time information indicates a usable time, and the electronic device determines a coefficient on the basis of a combination of the information of operation conditions before the change and the changed information of operation conditions, and calculates the usable time after the change by multiplying the usable time before the change by the coefficient.

11. In the management method of an electronic device according to the appendix 9 described above, the time information indicates a balance of a prepaid amount, the electronic device calculates the usable time after the change by dividing the balance by a constant determined on the basis of the changed information of operation conditions.

12. In the management method of an electronic device according to any one of the appendixes 9 to 11 described above, wherein the electronic device outputs at least one of the usable time after the change and an expiration period calculated using the usable time after the change.

13. In the management method of an electronic device according to any one of the appendixes 9 to 12 described above, the electronic device acquires and stores the first information of operation conditions, and acquires and stores the first time information.

14. In the management method of an electronic device according to the appendix 13 described above, the first information of operation conditions and the first time information have an electronic signature, the electronic device stores the first operation condition and stores the first time information when the electronic signature is authenticated.

15. In the management method of an electronic device according to any one of the appendixes 9 to 14 described above, the electronic device outputs a predetermined notification when a difference between an expiration period of the electronic device specified by the time information and a current date and time satisfies a reference, or when the usable time is equal to or less than a reference.

16. In the management method of an electronic device according to any one of the appendixes 9 to 15 described above, the electronic device is a display device or a projector.

17. A program causes an electronic device to have a function of storing information of operation conditions for specifying operation conditions of the electronic device, a function of storing time information that is information for specifying a usable time or an expiration period of the electronic device in the information of operation conditions, a function of receiving a change input of the information of operation conditions, and a function of changing the stored information of operation conditions according to the change input and calculating the usable time in the changed information of operation conditions.

18. In the program according to the appendix 17 described above, the time information indicates a usable time, and the electronic device has a function of determining a coefficient on the basis of a combination of the information of operation conditions before the change and the changed information of operation conditions and calculating the usable time after the change by multiplying the usable time before the change by the coefficient.

19. In the program according to the appendix 17 described above, the time information indicates a balance of a prepaid amount, and the electronic device calculates the usable time after the change by dividing the balance by a constant determined on the basis of the changed information of operation conditions.

20. In the program according to any one of the appendixes 17 to 19 described above, the electronic device has a function of outputting at least one of the usable time after the change and an expiration period calculated using the usable time after the change.

21. In the program according to any one of the appendixes 17 to 20 described above, the electronic device has a function of acquiring and storing the first information of operation conditions, and acquiring and storing the first time information.

22. In the program according to the appendix 21 described above, the first information of operation conditions and the first time information have an electronic signature, and the electronic device is caused to store the first information of operation conditions and store the first time information when the electronic signature is authenticated.

23. In the program according to any one of the appendixes 17 to 22 described above, the electronic device has a function of outputting a predetermined notification when a difference between an expiration period of the program specified by the time information and a current date and time satisfies a reference or when the usable time is equal to or less than a reference.

24. In the program according to any one of the appendixes 17 to 23 described above, the electronic device is a display device or a projector.

### REFERENCE SIGNS LIST

10 Electronic device

110 Operation condition storage

120 Time information storage

130 Change input

140 Changer

150 Output

160 Display

170 Initial input

180 Notifier

What is claimed is:

1. An electronic device comprising:
an operation condition storage storing information of operation conditions for specifying operation conditions of the electronic device;
a time information storage storing time information that is information for specifying at least one of a usable time and an expiration period of the electronic device in the information of operation conditions;
a change input receiving a change input of the information of operation conditions; and
a changer changing the information of operation conditions stored by the operation condition storage according to the change input and to calculate the usable time in the changed information of operation conditions.

2. The electronic device according to claim 1,
wherein the changer determines a coefficient on the basis of a combination of the information of operation conditions before the change and the changed information of operation conditions, and calculates the usable time after the change by multiplying the usable time before the change by the coefficient.

3. The electronic device according to claim 2,
wherein the time information indicates a balance of a prepaid amount, and
the changer calculates the usable time after the change by dividing the balance by a constant determined on the basis of the changed information of operation conditions.

4. The electronic device according to claim 1, further comprising:
an output outputting at least one of the usable time after the change and an expiration period calculated using the usable time after the change.

5. The electronic device according to claim 1, further comprising:
an initial input acquiring the first information of operation conditions to cause the operation condition storage to store the first information of operation conditions, and acquiring the first time information to cause the time information storage to store the first time information.

6. The electronic device according to claim 5,
wherein the first information of operation conditions and the first time information have an electronic signature, and
the initial input causes the operation condition storage to store the first information of operation conditions and causes the time information storage to store the first time information, when the electronic signature is authenticated.

7. The electronic device according to claim 1, further comprising:
a notifier outputting a predetermined notification when a difference between an expiration period of the electronic device specified by the time information and a current date and time satisfies a reference or when the usable time is equal to or less than a reference.

8. The electronic device according to claim 1,
wherein the electronic device is one of a display apparatus and a projector.

9. A management method of an electronic device, comprising:
storing information of operation conditions for specifying operation conditions of the electronic device;
storing time information that is information for specifying at least one of a usable time and an expiration period of the electronic device in the information of operation conditions;
receiving a change input of the information of operation conditions; and
changing the stored information of operation conditions according to the change input and calculating the usable time in the changed information of operation conditions.

10. A non-transitory computer readable storage medium that stores a computer program that causes an electronic device to perform:
a function of storing information of operation conditions for specifying operation conditions of the electronic device;
a function of storing time information that is information for specifying at least one of a usable time and an expiration period of the electronic device in the information of operation conditions;
a function of receiving a change input of the information of operation conditions; and
a function of changing the stored information of operation conditions according to the change input and calculating the usable time in the changed information of operation conditions.
